(19) United States
(12) Patent Application Publication
(10) Pub. No.: US 2022/0238973 A1
(43) Pub. Date: Jul. 28, 2022

(54) BATTERY AND ELECTRIC APPARATUS WITH SUCH BATTERY

(71) Applicant: Ningde Amperex Technology Limited, Ningde City (CN)

(72) Inventors: Ziqiang Yu, Ningde City (CN); Liqing Lin, Ningde City (CN); Zhifeng Huang, Ningde City (CN); Hui Wang, Ningde City (CN)

(73) Assignee: Ningde Amperex Technology Limited, Ningde City (CN)

(21) Appl. No.: 17/708,737

(22) Filed: Mar. 30, 2022

Related U.S. Application Data
(63) Continuation of application No. PCT/CN2021/081374, filed on Mar. 17, 2021.

(30) Foreign Application Priority Data
Mar. 31, 2020 (CN) 202020450681.2

(51) Int. Cl. H01M 50/627; H01M 50/186; H01M 50/531; H01M 10/0585

(52) U.S. Cl. CPC H01M 50/627; H01M 10/0585; H01M 50/531; H01M 50/186

(57) ABSTRACT

A battery, including a laminated cell, a first housing configured to accommodate the laminated cell, and a second housing mounted to the first housing, where the laminated cell includes an electrode assembly and a first tab. The electrode assembly includes a first side face, where the first tab is connected to the first side face, and the first housing, the first tab, and the first side face together define an injection space. The second housing is provided with an injection opening, where a projection of the injection space onto the second housing covers at least part of the injection opening. This application further provides an electric apparatus with the foregoing battery. This application can improve injection efficiency.

### CROSS REFERENCE TO THE RELATED APPLICATIONS

This application is a continuation under 35 U.S.C. § 120 of international patent application PCT/CN2021/081374 filed on Mar. 17, 2021, the entire content of which is incorporated herein by reference.

### TECHNICAL FIELD

This application relates to a battery and an electric apparatus with such battery.

### BACKGROUND

A battery usually includes a cell, a housing configured to accommodate the cell, and a top cover mounted to the housing. The top cover is usually provided with an injection opening, and an electrolyte is injected into the housing from the injection opening. The cell includes electrode plates and tabs connected to the electrode plates, where the tabs are configured to achieve electronic conduction.

However, because the injection opening is located on the top of the cell, the electrolyte is impeded by the electrode plates and the tabs dining injection, resulting in low injection efficiency, which in turn affects infiltration efficiency of the electrolyte to the electrode plates.

### SUMMARY

In order to address the foregoing shortcomings of the prior art, it is necessary to provide a battery that can improve injection efficiency, so as to improve infiltration efficiency of an electrolyte to electrode plates.

This application provides a battery, including a laminated cell, a first housing configured to accommodate the laminated cell, and a second housing mounted to the first housing, where the laminated cell includes an electrode assembly and a first tab. The electrode assembly includes a first side face, where the first tab is connected to the first side face, and the first housing, the first tab, and the first side face together define an injection space. The second housing is provided with an injection opening, where a projection of the injection space onto the second housing covers at least part of the injection opening.

In some embodiments of this application, a central axis of the injection opening is located inside the injection space.

In some embodiments of this application, the first tab includes a first face closer to the laminated cell, a second face farther away from the laminated cell, and a second side face connected between the first face and the second face. The first side face includes a flat region and a cambered region connected to the flat region, where the flat region, the second side face, and the first housing together define the injection space.

In some embodiments of this application, a distance between the second side face and a joint of the flat region and the cambered region is defined as L, and a distance between the central axis of the injection opening and the second side face is less than or equal to 0.5L.

In some embodiments of this application, the distance between the central axis of the injection opening and the second side face ranges from 0.4 mm to 1 mm.

In some embodiments of this application, a sealing piece is provided in the injection opening.

In some embodiments of this application, the injection opening, the sealing piece, and the second housing are all rounded, where a distance between a center of the injection opening and a center of the second housing is defined as M, a radius of the second housing is defined as R1, a radius of the sealing piece is defined as R2, and M, R1, and R2 satisfy M=R1−R2−0.2 nm.

In some embodiments of this application, the second housing is further provided with a through hole, where a pole electrically insulated from the second housing is provided in the through hole.

In some embodiments of this application, the electrode assembly includes a first electrode plate, a separator, and a second electrode plate, where the first tab is connected to the first electrode plate, a second tab is connected to the second electrode plate, the second tab is electrically connected to the pole, and the first tab is electrically connected to the first housing or the second housing.

In some embodiments of this application, the first housing is provided with a through hole, where a pole electrically insulated from the first housing is provided in the through hole, and the first tab is electrically connected to the pole.

This application further provides an electric apparatus, where the electric apparatus includes the foregoing battery.

In this application, the projection of the injection space onto the second housing covers at least part of the injection opening, so that during injection, electrolyte can bypass the laminated cell and directly flow into the injection space from the injection opening. Therefore, this application can improve injection efficiency, thereby improving infiltration efficiency of the electrolyte to the electrode plates.

### BRIEF DESCRIPTION OF DRAWINGS

FIG. 1 is a schematic structural exploded view of a battery according to an embodiment of this application.

FIG. 2 is a top view of the battery shown in FIG. 1.

FIG. 3 is a cross-sectional view of the battery shown in FIG. 1.

FIG. 4 is a top view of the battery shown in FIG. 1 without a second housing.

FIG. 5 is a schematic structural exploded view of a battery according to another embodiment of this application.

FIG. 6 is a cross-sectional view of the battery shown in FIG. 5.

FIG. 7 is a cross-sectional view of a battery according to another embodiment of this application.

FIG. 8 is a schematic structural diagram of an electric apparatus according to an embodiment of this application.

### REFERENCE SIGNS OF MAIN COMPONENTS

electric apparatus 1
laminated cell 10
electrode assembly 11
first electrode plate 11a
second electrode plate 11b
first tab 12
second tab 13
first housing 20
second housing 30
injection opening 31
sealing piece 32
through hole 33
pole 34
battery 100, 200, 300
injection space 101
first side face 111
first adapting piece 120
first face 121
second face 122
second side face 123
second adapting piece 130
flat region 1110
cambered region 1111
central axis A
distance L, M
radius R1, R2

This application will be further described with reference to the accompanying drawings in the following specific embodiments.

### DETAILED DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application.

Unless otherwise defined, all technical and scientific terms used herein shall have the same meanings as commonly understood by those skilled in the art to which this application belongs. The terms used herein in the specification of this application are merely intended to describe specific embodiments but not intended to limit this application.

The following describes in detail some embodiments of this application with reference to the accompanying drawings. In absence of conflicts, the following embodiments and features in the embodiments may be combined.

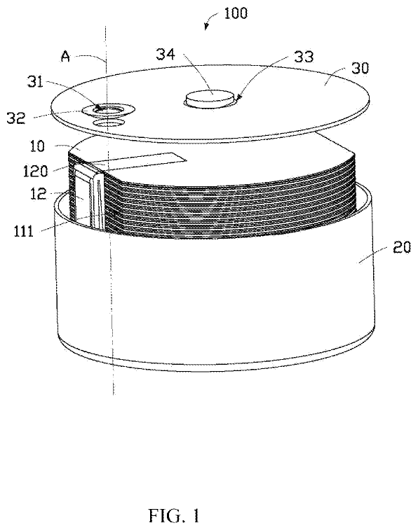

Referring to FIG. 1 to FIG. 4, an embodiment of this application provides a battery 100, including a laminated cell 10, a first housing 20 configured to accommodate the laminated cell 10, and a second housing 30 mounted to the first housing 20. The laminated cell 10 includes an electrode assembly 11 and a first tab 12.

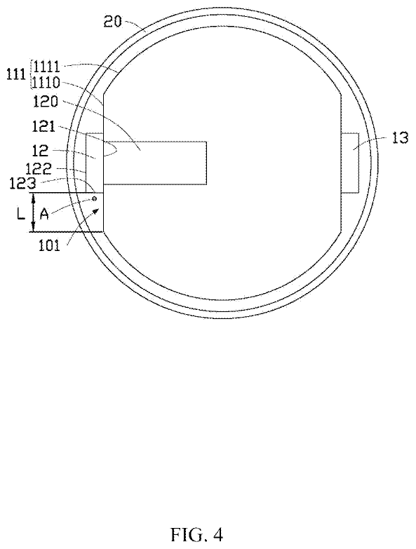

The electrode assembly 11 includes a first side face 111, where the first tab 12 is connected to the first side face 111. The first housing 20, the first tab 12, and the first side face 111 together define an injection space 101 (as shown in FIG. 4). The second housing 30 is provided with an injection opening 31, where a projection of the injection space 101 onto the second housing 30 covers at least part of the injection opening 31.

In this application, the projection of the injection space 101 onto the second housing 30 covers at least part of the injection opening 31, so that during injection, electrolyte can bypass the laminated cell 20 and directly flow into the injection space 101 from the injection opening 31. Therefore, this application can improve injection efficiency, thereby improving infiltration efficiency of the electrolyte to electrode plates.

As shown in FIG. 4, in an embodiment, a central axis A of the injection opening 31 is located inside the injection space 101. The injection opening 31 may be in a geometrically symmetric shape, such as a rounded, elliptic, square, or hexagonal shape. The central axis A of the injection opening 31 is located inside the injection space 101, such that the projection of the injection space 101 onto the second housing 30 and the injection opening 31 have a larger overlapping area, further ensuring that the electrolyte is not impeded by the laminated cell 10 during injection.

It can be understood that, in other embodiments, the injection opening 31 may be in other asymmetric shapes, which is not limited in this application. The injection opening 31 may be formed by stamping, mechanical cutting, or the like.

As shown in FIG. 4, in an embodiment, the first tab 12 includes a first face 121 closer to the laminated cell 10, a second face 122 farther away from the laminated cell 10, and a second side face 123 connected between the first face 121 and the second face 122. The first side face 111 includes a flat region 1110 and a cambered region 1111 connected to the flat region 1110, where the flat region 1110, the second side face 123, and the first housing 20 together define the injection space 101. As shown in FIG. 4, a cross section of the injection space 101 is roughly triangular. Therefore, a region of the injection space 101 closer to the first tab 12 is larger than a region of the injection space 101 farther away from the first tab 12.

In an embodiment, a distance between the second side face 123 and a joint of the flat region 1110 and the cambered region 1111 is defined as L, and a distance between the central axis A of the injection opening 31 and the second side face 123 is less than or equal to 0.5L. In this way, the central axis A of the injection opening 31 is closer to the first tab 12, such that electrolyte flows into a region with a larger cross section in the injection space 101 during injection, further ensuring that the electrolyte is not impeded by the laminated cell 10 during injection.

Further, the distance between the central axis A of the injection opening 31 and the second side face 123 ranges from 0.4 mm to 1 mm.

As shown in FIG. 1, in an embodiment, a sealing piece 32 is provided in the injection opening 31. After injection is completed, the injection opening 31 is sealed by using the sealing piece 32, preventing the injected electrolyte from spilling over or preventing external impurities from entering the battery 100. The sealing piece 32 is made of elastic materials. The sealing piece 32 is fastened into the injection opening 31 through elastic deformation force generated by stress. In other embodiments, the sealing piece may alternatively be a sealing nail made of weldable materials (such as stainless steel or aluminum alloy). After the sealing nail is inserted into the injection opening 31, the sealing nail is fastened to the second housing 30 by laser welding. In this way, the injection opening 31 can be reliably sealed.

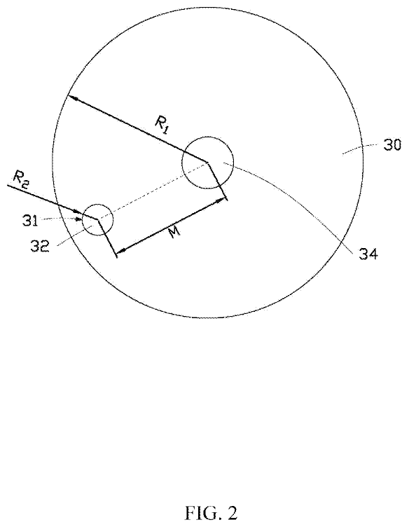

As shown in FIG. 2, in an embodiment, the injection opening 31, the sealing piece 32, and the second housing 30 are all rounded, where a distance between a center of the injection opening 31 and a center of the second housing 30 is defined as M, a radius of the second housing 30 is defined as R1, a radius of the sealing piece 32 is defined as R2, and M, R1, and R2 satisfy M=R1−R2−0.2 mm (0.2 mm is wall thickness of the first housing 20, and according to the relational formula, the sealing piece 32 does not affect welding of the first housing 20 and the second housing 30).

As shown in FIG. 1 to FIG. 3, in an embodiment, the second housing 30 is further provided with a through hole 33, where a pole 34 electrically insulated from the second housing 30 is provided in the through hole 33. As shown in FIG. 2, the pole 34 may be located at the center of the second housing 30.

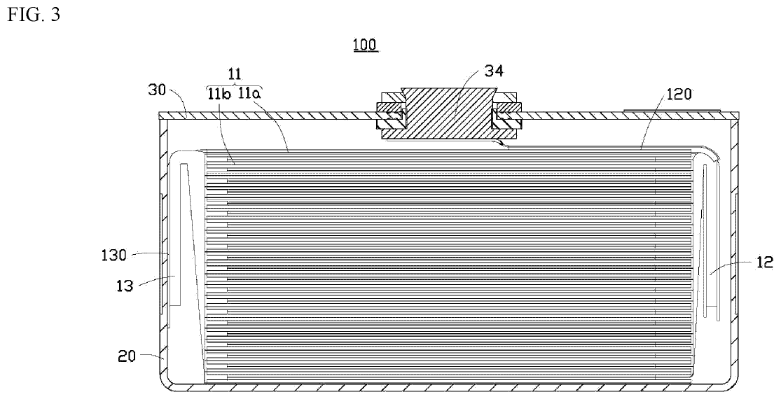

Further, as shown in FIG. 3, the electrode assembly 11 includes a first electrode plate 11a, a second electrode plate 11b, and a separator (not shown in the figure) located between the first electrode plate 11a and the second electrode plate 11b that are stacked, where the first tab 12 is connected to the first electrode plate 11a. A second tab 13 is connected to the second electrode plate 11b, the first tab 12 is electrically connected to the pole 34, and the second tab 13 is electrically connected to the first housing 20 or the second housing 30.

Specifically, the first tab 11a includes a first current collector and a first active material layer provided on a surface of the first current collector, where the first tab 12 may be electrically connected to the first current collector by welding, and electrically connected to the pole 34 by using a first adapting piece 120. The second electrode plate 11b includes a second current collector and a second active material layer provided on a surface of the second current collector, where the second tab 13 may be electrically connected to the second current collector by welding, and electrically connected to the first housing 20 or the second housing 30 by using a second adapting piece 130.

More specifically, the first housing 20 and the second housing 30 may be made of metal. For example, the first housing 20 and the second housing 30 may be made of steel alloy, aluminum alloy, iron alloy, copper alloy, nickel alloy, or the like.

By electrically connecting the first tab 12 to the pole 34, the pole 34 can present the same polarity as the first electrode plate 11a. By electrically connecting the second tab 13 to the first housing 20 or the second housing 30, when the first housing 20 and the second housing 30 are fastened by welding, the first housing 20 and the second housing 30 can generally present the same polarity as the second electrode plate 11b; when the first housing 20 and the second housing 30 are fastened by using an insulating pad, the first housing 20 or the second housing 30 can present the same polarity as the second electrode plate 11b.

As shown in FIG. 1 and FIG. 3, the battery 100 in this embodiment is a button cell, and the first housing 20 and the second housing 30 are both made of stainless steel. When preparation, the first housing 20 and the second housing 30 may be made into required shapes by laser cutting, machine tool processing, or other processes. The first housing 20 may alternatively be made into a scour hole by stamping forming, so as to accommodate the laminated cell 10.

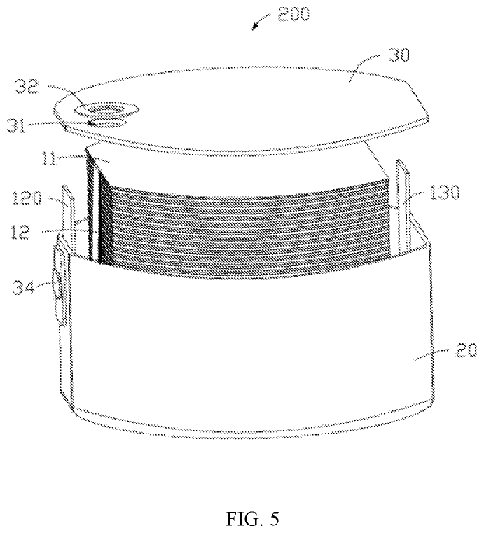

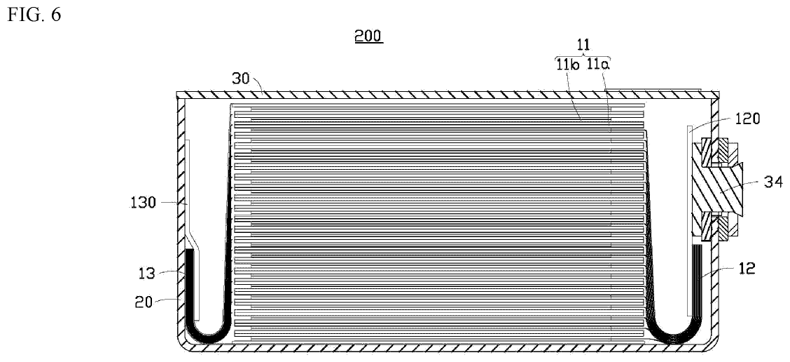

Referring to FIG. 5 and FIG. 6, some other embodiments of this application further provide a battery 200. The difference from the battery 100 is that the pole 34 electrically connected to the first tab 12 is located on the first housing 20. The pole 34 is electrically insulated from the first housing 20.

More specifically, the pole 34 may be located on a side wall of the first housing 20. The first tab 12 is electrically connected to the pole 34. The second tab 13 is electrically connected to the first housing 20 or the second housing 30.

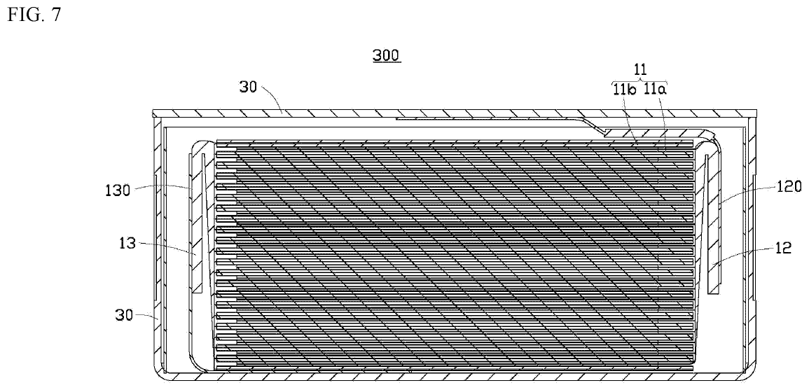

Referring to FIG. 7, another embodiment of this application further provides a battery 300. The difference from the battery 100 is that no pole is provided on the first housing 20 and the second housing 30. The first housing 20 and the second housing 30 are fastened by using a sealing ring (not shown in the figure), that is, the first housing 20 and the second housing 30 are electrically insulated by using the sealing ring. The first tab 12 is electrically connected to the second housing 30, and the second tab 13 is electrically connected to the first housing 20.

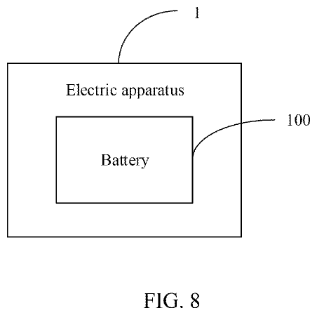

Referring to FIG. 8, this application further provides an electric apparatus 1, where the electric apparatus 1 includes the foregoing battery 100 (or the battery 200 or 300). The electric apparatus 1 may be a consumer electronic product (such as a mobile communications apparatus, a tablet computer, or a notebook computer), an electric tool, an unmanned aerial vehicle, an energy storage apparatus, a power apparatus, or the like. Referring to FIG. 8, in an embodiment, the electric apparatus 1 is an electric vehicle.

The foregoing descriptions are merely preferable embodiments of this application, but are not intended to limit this application. Any modification, equivalent replacement, or improvement made without departing from the spirit and principle of this application shall fall within the protection scope of this application.

What is claimed is:

1. A battery, comprising: a laminated cell, a first housing configured to accommodate the laminated cell, and a second housing mounted to the first housing, wherein the laminated cell comprises an electrode assembly and a first tab;
the electrode assembly comprises a first side face, wherein the first tab is connected to the first side face;
the first housing, the first tab and the first side face together define an injection space; and
the second housing is provided with an injection opening, wherein a projection of the injection space onto the second housing covers at least part of the injection opening.

2. The battery according to claim 1, wherein a central axis of the injection opening is located inside the injection space.

3. The battery according to claim 2, wherein the first tab comprises a first face, a second face and a second side face connected between the first face and the second face; the first face is a face of the first tab towards the laminated cell and the second face is a face of the tab away from the laminated cell; and
the first side face comprises a flat region and a cambered region connected to the flat region; wherein the flat region, the second side face and the first housing together define the injection space.

4. The battery according to claim 3, wherein a distance between the second side face and a joint of the flat region and the cambered region is defined as L, and a distance between the central axis of the injection opening and the second side face is less than or equal to 0.5L.

5. The battery according to claim 4, wherein the distance between the central axis of the injection opening and the second side face ranges from 0.4 mm to 1 mm.

6. The battery according to claim 1, wherein a sealing piece is provided in the injection opening; the injection opening, the sealing piece and the second housing are all rounded;
wherein a distance between a center of the injection opening and a center of the second housing is defined as M, a radius of the second housing is defined as R1, a radius of the sealing piece is defined as R2, and M=R1−R2−0.2 mm.

7. The battery according to claim 1, wherein the second housing is further provided with a through hole, wherein a pole electrically insulated from the second housing is provided in the through hole.

8. The battery according to claim 7, wherein the electrode assembly comprises a first electrode plate, a second electrode plate and a separator located between the first electrode plate and the second electrode plate; the first electrode plate, the second electrode plate and the separator are stacked, wherein the first tab is connected to the first electrode plate, a second tab is connected to the second electrode plate, the first tab is electrically connected to the pole, and the second tab is electrically connected to the first housing or the second housing.

9. The battery according to claim 1, wherein the first housing is provided with a through hole, wherein a pole electrically insulated from the first housing is provided in the through hole, and the first tab is electrically connected to the pole.

10. The battery according to claim 1, wherein the first housing and the second housing are electrically insulated by using a sealing ring, the first tab is electrically connected to the second housing, and the second tab is electrically connected to the first housing.

11. An electric apparatus, comprising the battery according to claim 1.

12. The electric apparatus according to claim 11, wherein a central axis of the injection opening is located inside the injection space.

13. The electric apparatus according to claim 12, wherein the first tab comprises a first face, a second face, and a second side face connected between the first face and the second face; the first face is a face of the first tab towards the laminated cell and the second face is a face of the tab away from the laminated cell; and the first side face comprises a flat region and a cambered region connected to the flat region, wherein the flat region, the second side face and the first housing together define the injection space.

14. The electric apparatus according to claim 13, wherein a distance between the second side face and a joint of the flat region and the cambered region is defined as L, and a distance between the central axis of the injection opening and the second side face is less than or equal to 0.5L.

15. The electric apparatus according to claim 14, wherein the distance between the central axis of the injection opening and the second side face ranges from 0.4 mm to 1 mm.

16. The electric apparatus according to claim 11, wherein a sealing piece is provided in the injection opening; the injection opening, the sealing piece, and the second housing are all rounded, wherein a distance between a center of the injection opening and a center of the second housing is defined as M, a radius of the second housing is defined as R1, a radius of the sealing piece is defined as R2, and M=R1−R2−0.2 mm.

17. The electric apparatus according to claim 11, wherein the second housing is further provided with a through hole, wherein a pole electrically insulated from the second housing is provided in the through hole.

18. The electric apparatus according to claim 17, wherein the electrode assembly comprises a first electrode plate, a second electrode plate, and a separator located between the first electrode plate and the second electrode plate; the first electrode plate, the second electrode plate and the separator are stacked, wherein the first tab is connected to the first electrode plate, a second tab is connected to the second electrode plate, the second tab is electrically connected to the pole, and the first tab is electrically connected to the first housing or the second housing.

19. The electric apparatus according to claim 11, wherein the first housing is provided with a through hole, wherein a pole electrically insulated from the first housing is provided in the through hole, and the first tab is electrically connected to the pole.

20. The electric apparatus according to claim 11, wherein the first housing and the second housing are electrically insulated by using a sealing ring, the first tab is electrically connected to the second housing, and the second tab is electrically connected to the first housing.
